(19) United States
(12) Patent Application Publication
(10) Pub. No.: US 2020/0278296 A1
(43) Pub. Date: Sep. 3, 2020

(54) TESTING DEVICE FOR VARIABLE LIGHT TRANSMITTANCE WINDOW

(71) Applicant: HAPDONG HITECHGLASS, LTD., Eumseong-Gun (KR)

(72) Inventor: Byung Seok YU, Goyang (KR)

(21) Appl. No.: 16/628,998

(22) PCT Filed: Nov. 20, 2018
(86) PCT No.: PCT/KR2018/014246

§ 371 Date: Jan. 6, 2020

(30) Foreign Application Priority Data
Nov. 23, 2017 (KR) 10-2017-0157490

(51) Int. Cl. G01N 21/59; G01N 21/958

(52) U.S. Cl. CPC G01N 21/59; G01N 2021/9586; G01N 21/958

(57) ABSTRACT

The present invention relates to a testing device for a variable light transmittance window, and a testing device for a variable light transmittance window according to one embodiment of the present invention comprises: a light source unit for irradiating light to a variable light transmittance window to measure optical characteristics of a suspended particle device (SPD) film; a detection unit for detecting the light irradiated from the light source unit and transmitted through the variable light transmittance window and outputting an electrical signal by means of the detected light; an AC power supply unit for supplying AC power to the variable light transmittance window; and a terminal for calculating the optical characteristics of the light transmittance variable window by using the electrical signal output from the detection unit. According to the present invention, there is an effect that makes it possible to automatically measure a physical parameter for confirming the optical characteristics of the variable light transmittance window.

### TECHNICAL FIELD

The present invention relates to a testing device for variable light transmittance windows, and, more particularly, to a testing device for variable light transmittance windows, which is adapted to evaluate characteristics of transmittance of visible light depending upon voltage applied to a variable light transmittance window capable of adjusting light transmittance through application of voltage.

### BACKGROUND ART

A suspended particle device (SPD) window is a variable light transmittance window having a structure wherein a liquid floating particle layer having rod-shaped floating nanoparticles is interposed between two films each having an electrically conductive transparent layer. In such a variable light transmittance window, the floating nanoparticles are randomly arranged and exhibit a dart blue color due to a tendency to absorb light upon non application of AC voltage. However, when an AC voltage of about 20V to 100V at about 60 Hz or more is applied thereto, the floating nanoparticles are arranged to allow light to pass through the variable light transmittance window.

Such a variable light transmittance window has variable light transmittance depending upon frequency and voltage of AC power applied thereto, and, in order to confirm optical characteristics depending upon AC voltage applied to the variable light transmittance window, there is a need for measurement of physical variables, such as an optical density (OD), an optical density ratio (ODR), a rise time (msec), and a decay time (msec).

FIG. 1 is a schematic view of a typical testing device for variable light transmittance windows.

Referring to FIG. 1, for measurement of variable light transmittance, a typical system includes a light unit 13 emitting light towards a variable light transmittance window 11, a detector 15 detecting a voltage signal corresponding to the light having passed through the variable light transmittance window, and an oscilloscope 17 adapted to measure a rise time and a decay time of the voltage signal. In addition, the optical density (OD) and the optical density ratio (ODR) are calculated based on measurement results obtained from other spectroscopes. Here, an AC power source 11 may be connected to the variable light transmittance window 11 to supply AC voltage thereto.

As such, for confirmation of optical characteristics of the variable light transmittance window, the typical system has an inconvenience due to manual operation corresponding to two stages of measurement and thus has a problem of consumption of labor and time.

### DISCLOSURE

### Technical Problem

It is an aspect of the present invention to provide a testing device for variable light transmittance windows, which can automatically measure physical variables to confirm optical characteristics of a variable light transmittance window.

### Technical Solution

In accordance with one aspect of the present invention, a testing device for variable light transmittance windows includes: a light source emitting light towards a variable light transmittance window to measure optical characteristics of a suspended particle device (SPD) film; a detector detecting the light emitted from the light source and having passed through the variable light transmittance window, the detector outputting an electrical signal corresponding to the detected light; an AC power source supplying AC power to the variable light transmittance window; and a terminal calculating optical characteristics of the variable light transmittance window based on the electrical signal output from the detector.

The optical characteristics of the variable light transmittance window may include an optical density (OD), an optical density ratio (ODR), a rise time (msec), and a decay time (msec).

The testing device may further include a data processor processing data with respect to the electrical signal output from the detector and transmitting the processed data to the terminal.

The AC power source may include: a function generator generating AC power to be supplied to the variable light transmittance window; a high voltage amplifier amplifying the AC power generated from the function generator; and a relay board supplying the AC power output from the high voltage amplifier to the variable light transmittance window.

The relay board may block the AC power supplied to the variable light transmittance window under control of the terminal.

The light source may be a white LED and the testing device may further include a DC power source supplying DC power to the light source.

The optical characteristics of the variable light transmittance window may be calculated by the terminal by setting the electrical signal output from the detector to a light transmittance of 0% upon no emission of the light to the detector and setting the electrical signal output from the detector to a light transmittance of 100% upon emission of the light from the light source to the detector without the variable light transmittance window.

The terminal may calculate light transmittance corresponding to the electrical signal output from the detector using a relationship between the electrical signal and the light transmittance based on the light transmittance of 0% and the light transmittance of 100%.

Among the optical characteristics of the variable light transmittance window, the optical density (OD) may be −log T (where T indicates the light transmittance), and the optical density ratio (ODR) may be calculated by (off OD)/(on OD) where off OD may indicate an OD when no AC voltage is applied to the variable light transmittance window and on OD may indicate an OD when AC voltage is applied to the variable light transmittance window.

Among the optical characteristics of the variable light transmittance window, a rise time in which light transmittance of the variable light transmittance window increases may indicate a time zone where the light transmittance constantly increases, and a decay time in which light transmittance of the variable light transmittance window decreases may indicate a time zone where the light transmittance constantly decreases.

### Advantageous Effects

According to the present invention, the testing device can automatically measure physical variables for conformation of optical characteristics of a variable light transmittance window.

In particular, the testing device can supply various waveforms to the variable light transmittance window through combination of a function generator and a high voltage amplifier, thereby enabling broad and systematic evaluation of electrical/optical characteristics of the variable light transmittance window.

Furthermore, the testing device can accurately measure light transmittance of the variable light transmittance window by generating little noise upon measurement through a light source, a detector and a data processor.

### DESCRIPTION OF DRAWINGS

FIG. 1 is a schematic view of a typical testing device for variable light transmittance windows.

FIG. 2 is a schematic view of a testing device for variable light transmittance windows according to one embodiment of the present invention.

FIG. 3 is a sectional view of a variable light transmittance window used for the testing device for variable light transmittance windows according to the embodiment of the present invention.

FIG. 4 is a view illustrating measurement of an optical density (OD) by the testing device for variable light transmittance windows according to the embodiment of the present invention.

FIG. 5 is a graph illustrating measurement of a rise time and a decay time by the testing device for variable light transmittance windows according to the embodiment of the present invention.

FIG. 6 is a graph illustrating a main wavelength range used by a light source of the testing device for variable light transmittance windows according to the embodiment of the present invention.

FIG. 7 is a view illustrating conversion of voltage output from a detector into light transmittance in the testing device for variable light transmittance windows according to the embodiment of the present invention.

FIG. 8 is a view illustrating measurement of a rise time in the testing device for variable light transmittance windows according to the embodiment of the present invention.

FIG. 9 is a view illustrating measurement of a decay time in the testing device for variable light transmittance windows according to the embodiment of the present invention.

FIG. 10 to FIG. 12 are views of screens displaying a testing procedure of the testing device for variable light transmittance windows according to the embodiment of the present invention.

### BEST MODE

Hereinafter, embodiments of the present invention will be described with reference to the accompanying drawings.

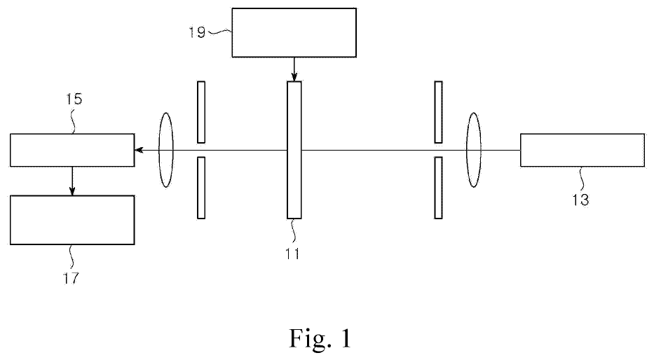

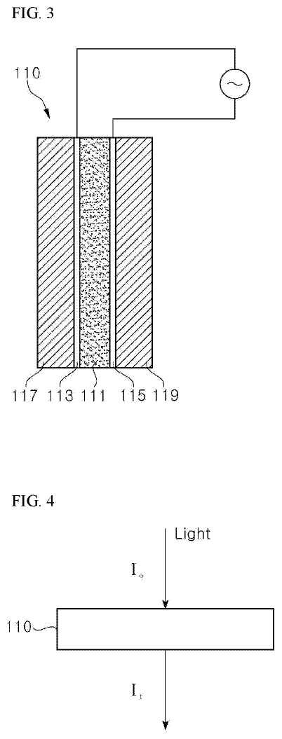

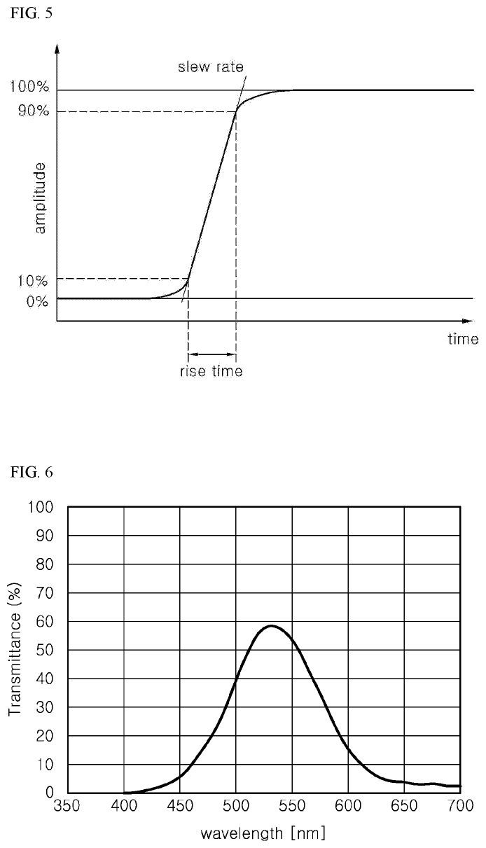

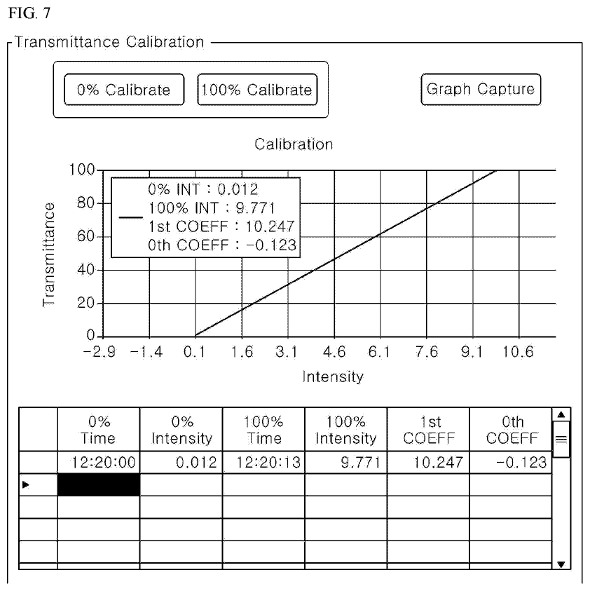

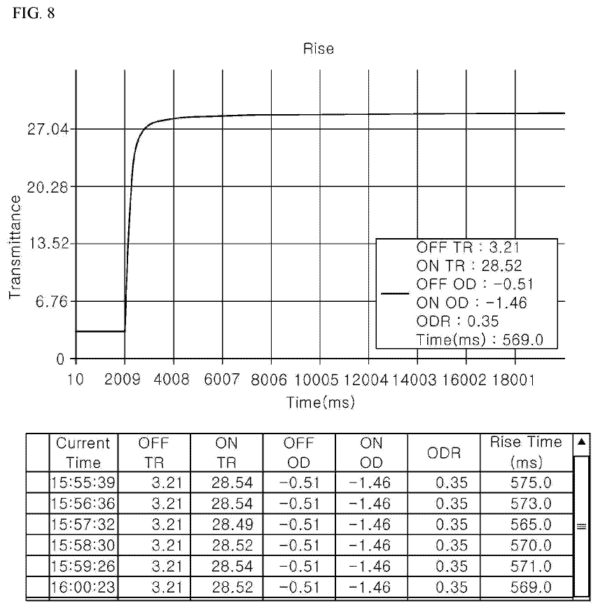

FIG. 1 is a schematic view of a typical testing device for variable light transmittance windows. FIG. 3 is a sectional view of a variable light transmittance window used for the testing device for variable light transmittance windows according to the embodiment of the present invention and FIG. 4 is a view illustrating measurement of an optical density (OD) by the testing device for variable light transmittance windows according to the embodiment of the present invention. Further, FIG. 5 is a graph illustrating measurement of a rise time and a decay time by the testing device for variable light transmittance windows according to the embodiment of the present invention, and FIG. 6 is a graph illustrating a main wavelength range used by a light source of the testing device for variable light transmittance windows according to the embodiment of the present invention.

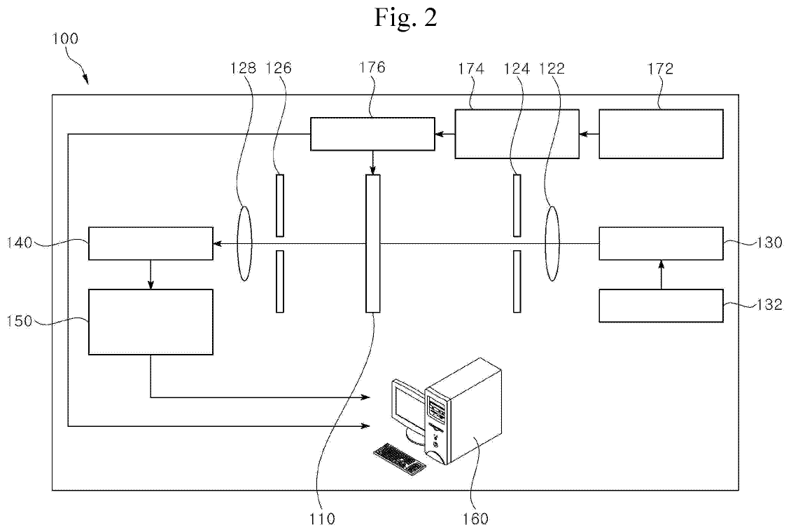

According to this embodiment, the testing device for variable light transmittance windows 100 can automatically measure an optical density (OD), an optical density ratio (ODR), a rise time (msec), and a decay time (msec), which are optical characteristics of a variable light transmittance window 110 upon application of AC voltage to the variable light transmittance window 110, at the same time. First, referring to FIG. 2, the testing device 100 according to the embodiment includes a light source 130, a detector 140, a data processor 150, a terminal 160, and an AC power source.

The light source 130 serves to emit light towards the variable light transmittance window 110 and may include a white light emitting device (LED). According to this embodiment, the white LED may have a peak wavelength of about 530 nm, as shown in FIG. 6, and may emit light at a power of about 5 W.

In addition, the testing device may be provided with a DC power supply 132 to supply stable DC power to the white LED. According to this embodiment, the DC power supply 132 may output an electric current of 0 A to 3 A at a voltage of 0 V to 30 V and applies electric power to the light source 130 in a constant current mode set by the testing device 100.

Here, the variable light transmittance window 110 is a suspended particle device (SPD) window, and includes a floating particle layer 111 interposed between first and second electrically conductive transparent layers 113, 115, as shown in FIG. 3. The floating particle layer 111 includes rod-shaped liquid crystals floating therein. In addition, the variable light transmittance window include first and second cover layers 117, 119 disposed on outer surfaces of the first and second electrically conductive transparent layers 113, 115 to protect the first and second electrically conductive transparent layers 113, 115, respectively. Each of the first and second cover layers 117, 119 may be formed of a glass or synthetic transparent material.

The AC power source may be electrically connected to the first and second electrically conductive transparent layers 113, 115 and the floating particles are aligned in the floating particle layer upon application of AC power to the first and second electrically conductive transparent layers 113, 115 to allow transmission of light therethrough.

Here, referring to FIG. 4, in order to measure the OD, the ODR, the rise time and the decay time of the variable light transmittance window 110, when the light source 130 emits light Io towards the variable light transmittance window 110, light It having passed through the variable light transmittance window 110 is detected. Here, when the light transmittance upon blocking transmission of light is defined as 0% and the light transmittance measured without the variable light transmittance window 110 is defined as 100%, the intensity of the light It may be measured through conversion of a voltage signal depending upon variation in the intensity of light into transmittance. As a result, the OD may be −log T. Here, T indicates light transmittance. In addition, the ODR is defined by (off OD)/(on OD). Here, off OD indicates an OD when no AC voltage is applied to the variable light transmittance window and on OD indicates an OD when AC voltage is applied to the variable light transmittance window.

In addition, upon application of AC voltage to the variable light transmittance window 110, the rise time in which the light transmittance of the variable light transmittance window increases indicates a time zone where the AC voltage stably increases and means a period of time for increase in voltage from 10% to 90% in FIG. 5. In addition, the decay time in which the light transmittance of the variable light transmittance window decreases indicates a time zone where the AC voltage stably decreases when application of AC voltage is blocked and means a period of time for decrease in voltage from 90% to 10% in FIG. 5.

As such, in order to measure the OD, the ODR, the rise time and the decay time of the variable light transmittance window 110, the testing device includes the detector 140, which detects light having passed through the variable light transmittance window 110. In this embodiment, the detector 140 may detect light in a wavelength range of 320 nm to 1,100 nm, may have an actual light reception area of 75.4 m², and may linearly output a voltage of 0 V to 10 V according to variation in the intensity of light.

The detector 140 may be electrically connected to the data processor 150, which processes data upon detection of light by the detector 140. The data processor 150 may process the data at a high rate per 0.1 ms in the detector 140.

Here, the light emitted from the light source 130 is converted into parallel light through a first lens 122 disposed between the light source 130 and the variable light transmittance window 110, and the converted parallel light passes through a first filter 124 such that the variable light transmittance window 110 can be irradiated with the converted parallel light. Then, the light having passed through the variable light transmittance window 110 may pass through a second filter 126 and may be collected by a second lens 128 to enter the detector 140. Here, each of the first and second filters 124, 126 may be a green filter.

In this embodiment, the testing device includes an AC power source to supply AC power to the variable light transmittance window 110. The AC power source may include a function generator 172, a high voltage amplifier 174, and a relay board 176.

The function generator 172 may have a maximum current output of 100 mA to supply AC power to the variable light transmittance window 110, which consumes an electric current of several dozen mA and allows frequency adjustment in the range of 0.5 Hz to 5 MHz. Furthermore, the amplitude of AC voltage may be adjusted to ±10V (an upper limit of 20V).

The high voltage amplifier 174 may amplify the AC power output from the function generator 172. The high voltage amplifier 174 may adjust the voltage of the AC power output from the function generator 172 in the range of 0 V to ±140 V, and the frequency of the AC power in the range of 5 Hz to 100 kHz. Furthermore, the waveform of the AC power may be adjusted by selecting a square wave, a sawtooth wave, and a sine wave.

The relay board 176 is a communicable component and may be configured to turn on/off AC power supplied to the variable light transmittance window 110 through communication.

The terminal 160 may store the data processed by the data processor 150 and may receive data from the relay board 176. In addition, a user can control the relay board 176 through the terminal 160 and calculate the OD, the ODR, the rise time and the decay time based on the data processed by the data processor 150.

The terminal 160 may include a PC, a notebook computer, or a tablet PC.

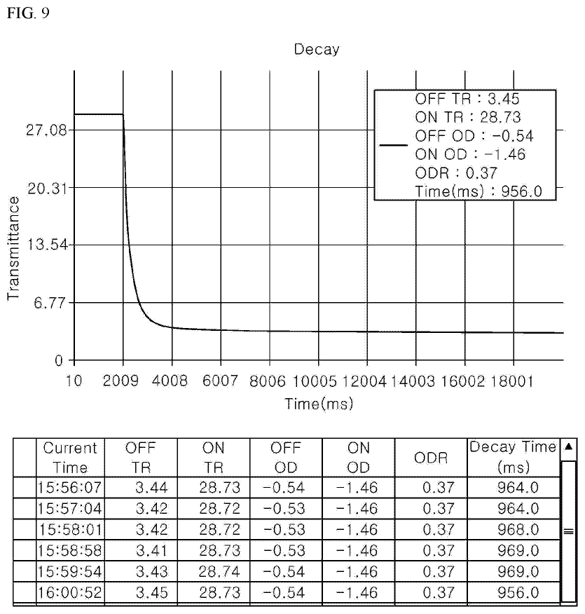

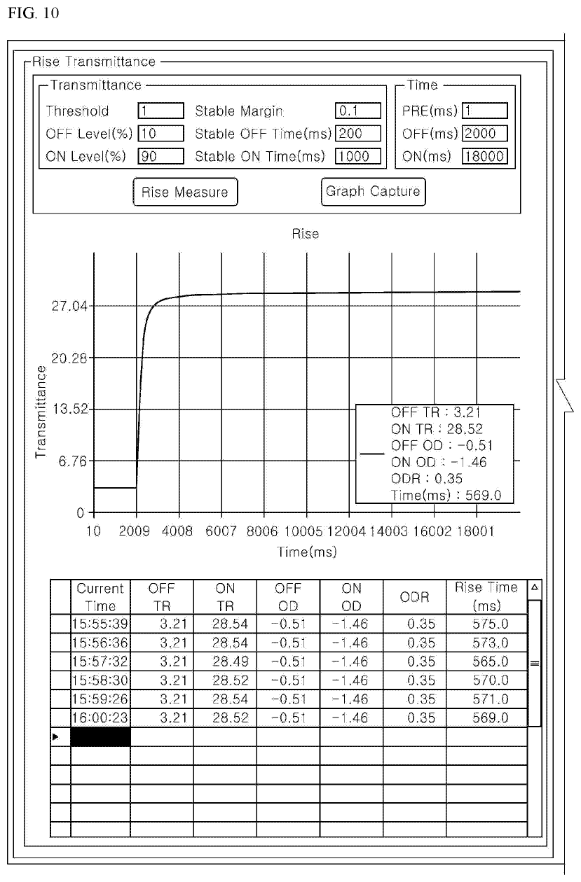

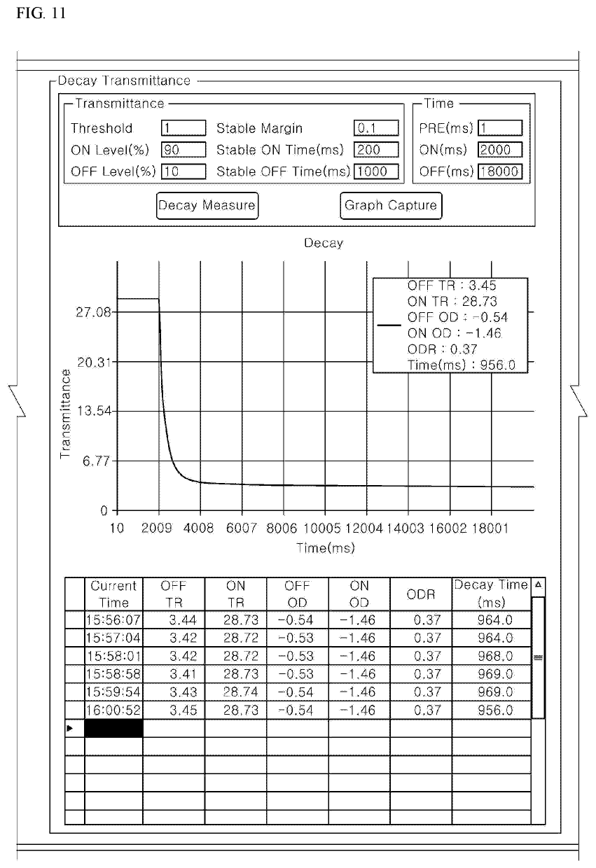

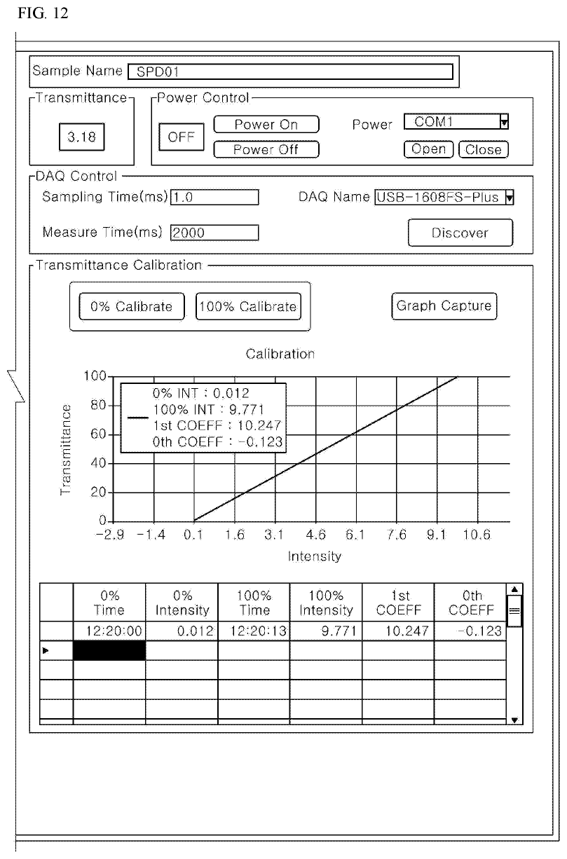

FIG. 7 is a view illustrating conversion of voltage output from a detector into light transmittance in the testing device for variable light transmittance windows according to the embodiment of the present invention. FIG. 8 is a view illustrating measurement of a rise time in the testing device for variable light transmittance windows according to the embodiment of the present invention and FIG. 9 is a view illustrating measurement of a decay time in the testing device for variable light transmittance windows according to the embodiment of the present invention. FIG. 10 to FIG. 12 are views of screens displaying a testing procedure of the testing device for variable light transmittance windows according to the embodiment of the present invention.

In order to measure the OD, the ODR, the rise time and the decay time of the variable light transmittance window 110 using the testing device 100, there is a need for conversion of a voltage signal output from the detector 140 into light transmittance of the variable light transmittance window 110. To this end, the light source 130 is turned on to stabilize the intensity of light emitted from the light source 130. Here, stabilization of the light source may be performed for about 1 hour. In addition, with an inlet of the detector 140 blocked to prevent light from entering the detector 140, a voltage signal (for example, 0.012 V) output from the detector 140 is set to a light transmittance of 0%. Here, when light emitted from the light source 130 enters the detector 140 with the variable light transmittance window 110 not disposed, a voltage signal (for example, 9.771 V) output from the detector 140 is set to a light transmittance of 100%.

Further, as shown in FIG. 7, a voltage signal output from the detector 140 may be converted into light transmittance based on a primary function using the light transmittance of 0% and the light transmittance of 100%.

FIG. 8 shows a measurement result of the rise time and FIG. 9 shows a measurement result of the decay time upon application of AC power having a frequency of 1 kHz, a square wave and ±100V to the variable light transmittance window 110.

Further, as shown in FIG. 10 to FIG. 12, the above results may be disposed on a screen of the terminal 160. To this end, according to this embodiment, a software program capable of automatically calculating optical characteristics of the variable light transmittance window 110 may be installed in the terminal 160. FIG. 10 to FIG. 12 show an output screen of the software program installed in the terminal 160, in which one output screen is divided into three parts shown in FIG. 10 to FIG. 12. That is, FIG. 10 shows a left part of the output screen, FIG. 11 shows a middle part of the output screen, and FIG. 12 shows a right part of the output screen.

Although some embodiments have been described herein with reference to the accompanying drawings, it should be understood that these embodiments are provided for illustration only and are not to be construed in any way as limiting the present invention. Therefore, it should be understood that the scope of the present invention should be defined by the appended claims and equivalents thereto.

1. A testing device for variable light transmittance windows, comprising:
a light source emitting light towards a variable light transmittance window to measure optical characteristics of a suspended particle device (SPD) film;
a detector detecting the light emitted from the light source and having passed through the variable light transmittance window, the detector outputting an electrical signal corresponding to the detected light;
an AC power source supplying AC power to the variable light transmittance window; and
a terminal calculating optical characteristics of the variable light transmittance window based on the electrical signal output from the detector.

2. The testing device according to claim 1, wherein the optical characteristics of the variable light transmittance window comprise an optical density (OD), an optical density ratio (ODR), a rise time (msec), and a decay time (msec).

3. The testing device according to claim 1, further comprising:
a data processor processing data with respect to the electrical signal output from the detector and transmitting the processed data to the terminal.

4. The testing device according to claim 1, wherein the AC power source comprises: a function generator generating AC power to be supplied to the variable light transmittance window; a high voltage amplifier amplifying the AC power generated from the function generator; and a relay board supplying the AC power output from the high voltage amplifier to the variable light transmittance window.

5. The testing device according to claim 4, wherein the relay board blocks the AC power supplied to the variable light transmittance window under control of the terminal.

6. The testing device according to claim 1, wherein the light source is a white LED.

7. The testing device according to claim 1, further comprising:
a DC power source supplying DC power to the light source.

8. The testing device according to claim 1, wherein the optical characteristics of the variable light transmittance window are calculated by the terminal by setting the electrical signal output from the detector to a light transmittance of 0% upon no emission of the light to the detector and setting the electrical signal output from the detector to a light transmittance of 100% upon emission of the light from the light source to the detector without the variable light transmittance window.

9. The testing device according to claim 8, wherein the terminal calculates light transmittance corresponding to the electrical signal output from the detector using a relationship between the electrical signal and the light transmittance based on the light transmittance of 0% and the light transmittance of 100%.

10. The testing device according to claim 8, wherein, among the optical characteristics of the variable light transmittance window, the optical density (OD) is −log T (where T indicates the light transmittance).

11. The testing device according to claim 10, wherein, among the optical characteristics of the variable light transmittance window, the optical density ratio (ODR) is calculated by (off OD)/(on OD) where off OD indicates an OD when no AC voltage is applied to the variable light transmittance window and on OD indicates an OD when AC voltage is applied to the variable light transmittance window.

12. The testing device according to claim 1, wherein, among the optical characteristics of the variable light transmittance window, a rise time in which light transmittance of the variable light transmittance window increases indicates a time zone where the light transmittance constantly increases, and.

13. The testing device according to claim 1, wherein, among the optical characteristics of the variable light transmittance window, a decay time in which light transmittance of the variable light transmittance window decreases may indicate a time zone where the light transmittance constantly decreases.
